(19) United States
(12) Patent Application Publication
(10) Pub. No.: US 2012/0261145 A1
(43) Pub. Date: Oct. 18, 2012

(54) Hydraulic Walking Beam

(75) Inventor: Nelson J. Palen, Beloit, KS (US)

(73) Assignee: AGCO Corporation, Duluth, GA (US)

(21) Appl. No.: 13/330,834

(22) Filed: Dec. 20, 2011

Related U.S. Application Data
(60) Provisional application No. 61/427,909, filed on Dec. 29, 2010.

(51) Int. Cl. A01B 63/22

(52) U.S. Cl. 172/1; 172/400; 172/406

(57) ABSTRACT

A hydraulic walking beam method of a pull-type implement, the method comprising: receiving hydraulic fluid at a first hydraulic cylinder associated with a first gauge wheel assembly from a second hydraulic cylinder associated with a second gauge wheel assembly, the first and second gauge wheel assemblies coupled to a frame of a pull-type implement; extending a cylinder rod associated with the first hydraulic cylinder responsive to receiving the hydraulic fluid; and retracting a cylinder rod associated with the second hydraulic cylinder concurrently with the extending.

### RELATED APPLICATION

Under provisions of 35 U.S.C. §119(e), Applicant claims the benefit of U.S. provisional application No. 61/427,909, filed Dec. 29, 2010, which is incorporated herein by reference.

### BACKGROUND

In conventional implements, a lift mechanism may be used to switch the implement from a lowered, working position to a raised, transport position. However, such implements comprise large, rigid frames that may be unable to follow a ground contour, particularly when the towing vehicle and implement are on different heights and/or angles. For some implements, this may result in inefficient or low quality work, such as uneven ground penetration by a cultivator.

### SUMMARY

A hydraulic walking beam method of a pull-type implement, the method comprising: receiving hydraulic fluid at a first hydraulic cylinder associated with a first gauge wheel assembly from a second hydraulic cylinder associated with a second gauge wheel assembly, the first and second gauge wheel assemblies coupled to a frame of a pull-type implement; extending a cylinder rod associated with the first hydraulic cylinder responsive to receiving the hydraulic fluid; and retracting a cylinder rod associated with the second hydraulic cylinder concurrently with the extending.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a perspective view of an example pull-type implement for which an embodiment of a hydraulic walking beam may be employed.

FIG. 2 is a schematic diagram illustrating a forward, overall perspective view of an embodiment of a hydraulic walking beam relative to a frame of a pull-type implement.

FIG. 3 is a schematic diagram illustrating a forward perspective view of an embodiment of a hydraulic walking beam.

FIG. 4 is a schematic diagram that illustrates another embodiment of a hydraulic walking beam, and in particular, an example combined series and parallel hydraulic arrangement.

FIG. 5 is a flow diagram that illustrates an embodiment of an example hydraulic walking beam method.

### DETAILED DESCRIPTION

Certain embodiments of a hydraulic walking beam and associated systems and methods are disclosed. In one embodiment, the hydraulic walking beam is associated with plural (e.g., two) gauge wheel assemblies of a pull-type implement. Each gauge wheel assembly comprises, for instance, a double-acting hydraulic cylinder. The hydraulic cylinder of one gauge wheel assembly is hydraulically coupled to the hydraulic cylinder of the other gauge wheel in a parallel arrangement, enabling the free-flow of hydraulic fluid back-and-forth between the hydraulic cylinders. The transfer of hydraulic fluid (e.g., oil, or other hydrocarbon-based fluids) between the hydraulic cylinders creates a walking beam effect between the gauge wheel assemblies, with a somewhat similar effect as a mechanical walking beam.

Certain embodiments of a hydraulic walking beam enable field terrain-following capability. This terrain-following feature, combined with plural (e.g., two) rear lift wheels located beneath a frame of a pull-type implement (e.g., a cultivator center frame) creates a tripod effect whereby, in at least one embodiment, four (4) wheel locations maintain contact with a surface (e.g., ground) and each carry a respective share of the load at all or substantially all times.

With no walking beam action between the two gauge wheel assemblies, one of the wheels of the gauge wheel assemblies may carry (e.g., always) more or less than half of the load due to uneven terrain. Such an unequal load distribution may create a twisting effect on the cultivator center frame during field operations, which may result in less than desired (e.g., optimal) depth control of the ground engaging elements attached under the cultivator.

The following detailed description refers to the accompanying drawings. Wherever possible, the same reference numbers are used in the drawings and the following description to refer to the same or similar elements. While certain embodiments of the disclosure may be described, modifications, adaptations, and other implementations are possible as should be understood by one having ordinary skill in the art in the context of the disclosure. For example, substitutions, additions, or modifications may be made to the elements illustrated in the drawings, and the methods described herein may be modified by substituting, reordering, or adding stages to the disclosed methods. References hereinafter made to certain directions, such as, for example, “front”, “rear”, “left” and “right”, are made as viewed from the rear of the pull-type implement looking forwardly.

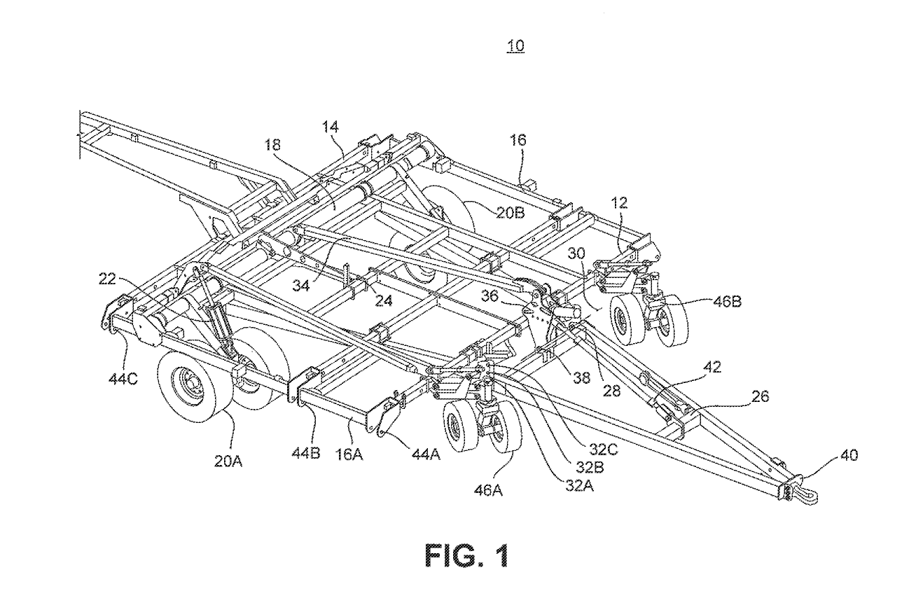

FIG. 1 is a perspective view of an example pull-type implement 10 (herein, also implement) that employs an embodiment of a hydraulic walking beam. It should be understood by one having ordinary skill in the art, in the context of the present disclosure, that the example components illustrated in FIG. 1 are merely illustrative, and should not be construed as implying any limitations upon the scope of the disclosure. The implement 10 may comprise a frame comprising a front cross-member 12, a rear cross-member 14 positioned substantially parallel to the front cross-member 12, and a plurality of frame rails 16A, 16B joining the front cross-member 12 to the rear cross-member 14. The frame of implement 10 may comprise a plurality of other members to provide structural support as needed for a work operation. For example, the frame may support a plurality of cultivating tiller blades. The blades may engage the ground while the implement is in a lowered, working position and may be raised out of contact with the ground while the implement is in a raised, transport position.

The implement 10 may further comprise a vertically adjustable rear wheel suspension rotatably mounted to the frame rails 16A, 16B of the frame comprising a lift axle assembly 18 and at least two laterally spaced ground-engaging wheels 20A, 20B rotatably mounted to the lift axle assembly 18. The vertically adjustable rear wheel suspension may further comprise at least one actuator 22 operably connected to the lift axle assembly 18, such as a hydraulic cylinder. The actuator 22 may comprise a hydraulic depth control valve that may contract a plunger on a valve, and stop at an adjustable work depth. For example, the actuator 22 may be set to lower a tiller blade attached to the frame of the implement 10 to a depth of six inches. The work depth may be indicated by a depth gauge 24. The actuator 22 may actuate the vertically adjustable rear wheel suspension and thereby move the frame between a lowered, working position, and a raised, transport position.

A tongue 26 may be coupled to the front cross-member 12 via at least one first pivot joint 28. The first pivot joint 28 may be operative to allow vertical movement between the tongue 26 and the frame of the implement 10 about a first pivot axis 30 according to changes in the ground's terrain level. The first pivot joint 28 may comprise one of a plurality of selectable attachment points 32A, 32B, 32C available on the frame of the implement 10. The selection of an attachment point 32 may be made in order to ensure that the frame remains substantially level. Each of attachment points 32A, 32B, 32C may be suitable for balancing heavier or lighter work tools attached to the frame.

A leveling linkage 34 may be coupled between the lift axle assembly 18 and a leveling arrangement 36 coupled to the tongue 26. The leveling arrangement 36 may be coupled to the front cross-member 12 and/or the tongue 26 at a second pivot joint 38. The leveling linkage 34 may be operable to maintain the frame in a substantially level orientation when the frame is being moved between the lowered, working position and the raised, transport position. In some embodiments, the leveling linkage 34 may be replaced with other arrangements that enable a similar functionality, or in some embodiments, the corresponding functionality may be omitted. The implement 10 may further comprise a hitch 40 at a front end of the tongue 26 for coupling the tongue 26 to a towing vehicle, such as a tractor.

The leveling arrangement 36 may be further coupled to the tongue 26 via an adjustable link 42 that may be operative to transfer motion between the leveling arrangement 36 and the tongue 26. A threaded adjustment of the adjustable link 42 may be operative to allow the implement to be used with different tractors of varying drawbar height.

The implement 10 may further comprise a plurality of attachment points 44A, 44B, 44C on the frame rails 16A, 16B. The attachment points 44A, 44B, 44C may be operative to couple at least one work element wing (not shown) to the frame of the implement 10.

The implement 10 may further comprise plural front gauge wheel assemblies (e.g., two), including in the depicted embodiment a first front gauge wheel assembly 46A and a second front gauge wheel assembly 46B (collectively or individually also referred to as, simply, gauge wheel assembly or assemblies). The gauge wheel assemblies 46A, 46B may be operative to engage the ground when the frame is in the lowered, working position, and the gauge wheel assemblies 46A, 46B may be maintained out of contact with the ground when the frame is in the raised, transport position. Further, the gauge wheel assemblies 46A, 46B comprise embodiments of a hydraulic walking beam that enable terrain following capabilities and/or equal or substantially equal load sharing, as explained further below. The gauge wheel assemblies 46A, 46B may each be coupled (e.g., mounted) to the front cross-member 12 at substantially equal distances from a respective joining of frame rails 16A, 16B to the front cross-member 12. For example, the gauge wheel assembly 46A may be mounted to the front cross-member 12 at a distance of one foot from a joining of the front cross-member 12 to the frame rail 16A and the gauge wheel assembly 46B may be mounted to the front cross-member 12 at the same distance of one foot from a joining of the front cross-member 12 to the frame rail 16B.

While in the lowered, working position, the gauge wheel assemblies 46A, 46B may maintain contact with the ground to maintain a constant work depth. The depth of gauge wheel assemblies gauge wheel assemblies 46A, 46B may be adjustable (e.g., via a directional valve located at the tractor in some embodiments or via actuator 22 in some embodiments). Further, the coupling of the tongue 26 to the frame of the implement 10 may also be adjusted to aid in balancing the contact with the ground. For example, where weight has been added to the rear of the implement 10, the tongue 26 may be attached in a top attachment point 32C in order to raise the line of draft and maintain contact of the gauge wheel assemblies 46A, 46B when going though a depression in a field's terrain and the tongue 26 is floating up. In some embodiments, the hydraulic walking beam enables maintenance of the setting of the tongue 26 to a regular working attachment point (e.g., without adjustment), due to the hydraulic walking beam terrain-following capability.

Each of the pivot joints described above may comprise, for example, a mating pin passed through a pair of pivot holes in a fork an external member and an interior pivot hole in a tab of an internal member situated within the fork of the external member. A bushing may be placed around the mating pin to reduce the effects of wear. The bushing may comprise a hardened material, such as carbon steel, and may be used to protect a housing from premature wear resulting from friction with the mating pin.

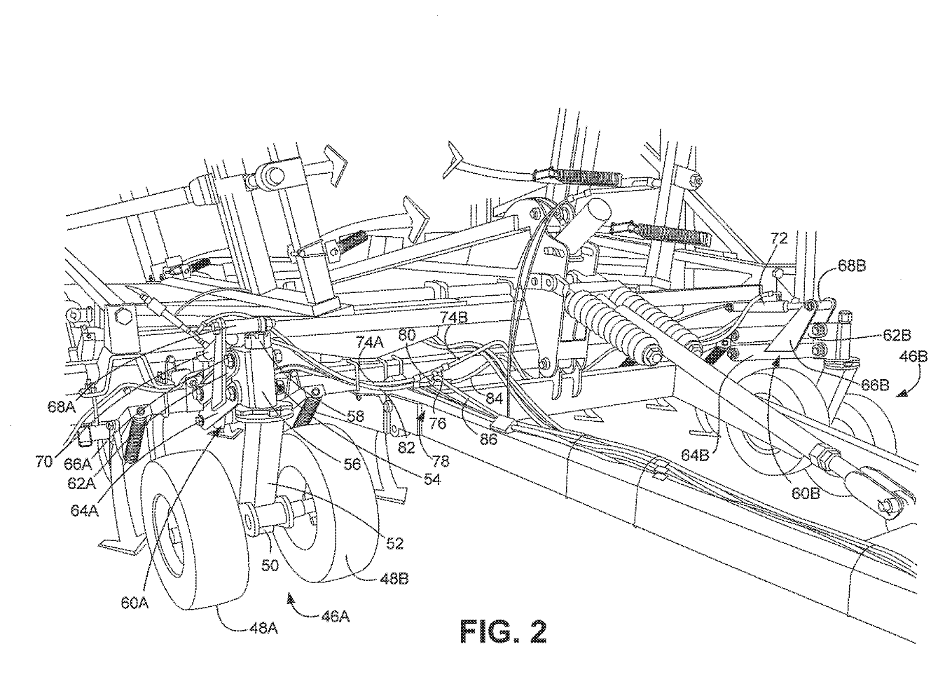

Having described an example implement 10 in which embodiments of a hydraulic walking beam may be employed, attention is directed to FIG. 2, which illustrates a forward perspective view of the gauge wheel assembly 46A, and to a lesser extent, gauge wheel assembly 46B. The focus of the following description is on the gauge wheel assembly 46A except where indicated otherwise below, with an understanding that the features described herein for the gauge wheel assembly 46A are mirrored identically (or at least in substantial extent) in the gauge wheel assembly 46B. The gauge wheel assembly 46A comprises two wheels 48A, 48B coupled in known manner to opposing ends of a walking beam 50. In some embodiments, a single wheel may be used. The walking beam 50 is coupled to an upstanding axle 52. The axle 52 is coupled to a castor pivot assembly 54. The castor pivot assembly 54 comprises a vertical housing 56 that surrounds a stud, the stud coupled (e.g., welded) to the axle 52. The stud is capped at its top by a hex nut 58. The castor pivot assembly 54 enables the wheels 48A, 48B to turn according to the direction of travel.

Coupled to the castor pivot assembly 54 of each gauge wheel assembly 46A, 46B is a parallel linkage 60A, 60B, each linkage 60A, 60B comprising an upper arm 62A, 62B (each having opposing side members) and a lower arm 64A, 64B (each having opposing side members), the upper arm 62A, 62B and the lower arm 64A, 64B each coupled to the frame (e.g., the front cross-member 12). Each parallel linkage 60A, 60B further comprises ears 66A, 66B, each having opposing side members that are coupled to opposing side members of the lower arm 64A, 64B. A cross member 68A, 68B is coupled between the opposing sides of the ears 66A, 66B, and further coupled (e.g., at approximately midway, and rearward facing) to a hydraulic cylinder 70, 72. The hydraulic cylinder 70 of the gauge wheel assembly 46A is hydraulically coupled in parallel to a hydraulic cylinder 72 of the gauge wheel assembly 46B via one or more hoses 74A, 74B. In the depicted embodiment, two hoses 74A and 74B are shown hydraulically coupled to one another via a coupler 76. In some embodiments, the coupler 76 may be omitted, and in some embodiments, additional hoses and couplers may be used for the parallel branch.

In some embodiments, the hydraulic cylinders 70, 72 are hydraulically coupled to a directional valve of a towing vehicle (not shown) via a tee assembly 78. The tee assembly 78 comprises a tee 80 with a connection to a first hose assembly 82 that is hydraulically coupled to the hydraulic cylinder 70, a connection to a second hose assembly 84 that is hydraulically coupled to the hydraulic cylinder 72, and a connection to a third hose assembly 86 that is coupled to a directional valve (represented in FIG. 2 as “DV” in schematic form). In some embodiments, hose assemblies 82, 84, and/or 86 may comprise plural hoses joined by one or more couplers. In the tee-based embodiment shown in FIG. 2, one purpose of this arrangement is to set an operating depth of the wheels 48A, 48B associated with the gauge wheel assembly 46A (and the wheels of the other gauge wheel assembly 46B). For instance, the hose assembly 86 is coupled to a directional valve on the towing vehicle (e.g., tractor), wherein an operator adjusts one or more controls (e.g., at an operator console on the tractor) that causes hydraulic adjustment via the directional valve of the operating depth, which is conveyed as a level of hydraulic fluid through the tee assembly 78 and to the gauge wheel assemblies 46A, 46B. After setting the depth, no further hydraulic fluid is transferred between the directional valve and the tee assembly 78 and gauge wheel assemblies 46A, 46B.

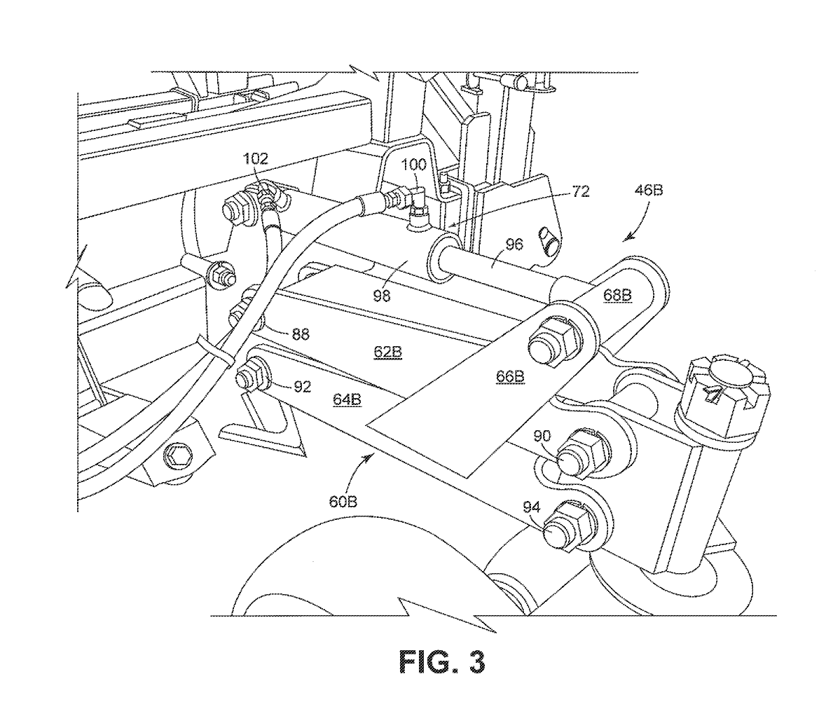

Attention is now directed to FIG. 3, which illustrates a parallel linkage 60B associated with the gauge wheel assembly 46B. It should be appreciated that the features described for gauge wheel assembly 46B are mirrored or substantially mirrored for the gauge wheel assembly 46A, and hence emphasis is directed to select portions of the gauge wheel assembly 46B. The parallel linkage 60B comprises the upper 62B and lower arms 64B and the ears 66B coupled to the lower arm 64B. The upper arm 62B comprises plural pivot points, including pivot points 88 (shown partially obscured by a hose) and 90. The lower arm 64B comprises plural pivot points, including pivot points 92 and 94. The hydraulic cylinder 72 comprises a rod 96 that retracts into and extends out of a main body 98 depending on the fluid level. Discharge or ingress of hydraulic fluid (e.g., from the other hydraulic cylinder 70) may be via connection 100 or connection 102. For instance, as is known to those having ordinary skill in the art, in one implementation, receipt of hydraulic fluid from the other hydraulic cylinder 70 may be at the connection 102, and in some implementations, receipt may be at connection 100 depending on the configured implementation. More importantly, as hydraulic fluid is received at the hydraulic cylinder 72, the rod 96 extends from the main body 98 concurrently (e.g., simultaneously) with the retraction of a rod back into the main body associated with the hydraulic cylinder 70. Similarly, as fluid exits from the hydraulic cylinder 72, the rod 96 retracts into the main body concurrently with an extension of a rod of the hydraulic cylinder 70 with the ingress of the fluid received from the hydraulic cylinder 72.

In operation, when the hydraulic cylinder 72 receives hydraulic fluid from the hydraulic cylinder 70, the receiving fluid causes the rod 96 to extend and hence exert a force against the cross member 68B, which in cooperation with a pivoting among the plural pivot points 88, 90, 92, and 94, causes a lowering of the arms 62B, 64B, such as when the surface upon which the wheels of the wheel assembly 46B travel dips (e.g., a ravine) relative to the surface elevation of the wheels 48A, 48B of the wheel assembly 46A. In concurrent manner, the rod of the hydraulic cylinder 70 retracts in view of the withdrawn hydraulic fluid, drawing the ears 66A back while the upper and lower arms 62A, 64B raise about the pivot points of the same, hence equalizing the load among the two gauge wheel assemblies 46A, 46B.

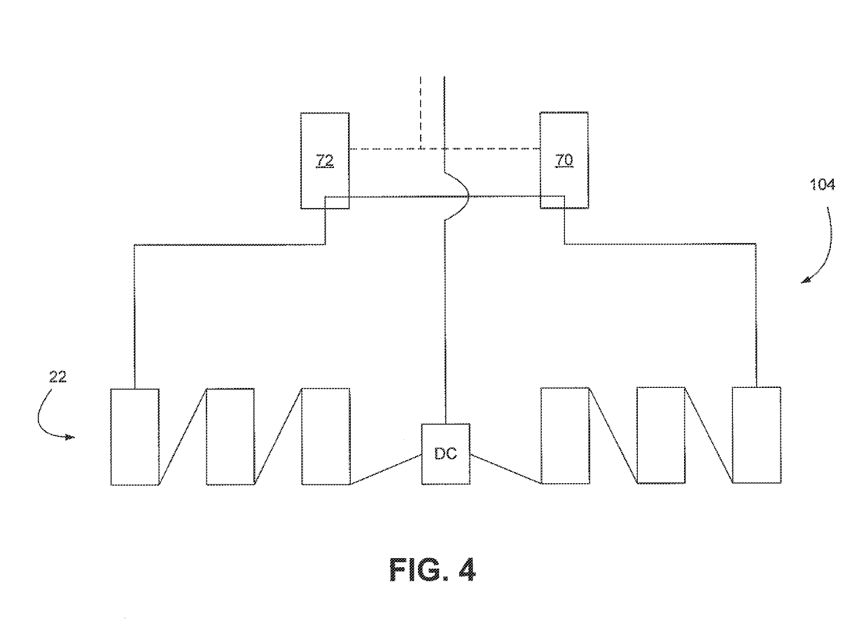

Although described in the context of depth control via a directional valve located at the towing vehicle, other embodiments of the hydraulic walking beam are contemplated. For instance, FIG. 4 illustrates another hydraulic circuit associated with a hydraulic walking beam, wherein the hydraulic cylinders 70, 72 are in parallel arrangement for the transfer of fluid (via dashed line representing parallel arrangement), similar to the aforementioned embodiments. In addition, the hydraulic fluid for purposes of depth control is achieved via a series (represented by the solid line between rectangular blocks in FIG. 4) hydraulic circuit 104 from one more main lift cylinders, such as main lift cylinders 22 coupled to the frame. For instance, the series/parallel arrangement depicted in FIG. 4 maintains automatic depth control (DC) between the implement lift wheels 20A, 20B and the gauge wheel assembly wheels, which eliminates the need for gauge wheels to be connected to a separate directional control valve on the tractor. Such a scenario (eliminating the need for a tractor directional control valve) may be used in an application where the gauge wheels maintain contact with the ground even during road transport and it eliminates the front-to-rear mechanical connection between the main lift wheels and the gauge wheels seen on some designs of other manufacturers.

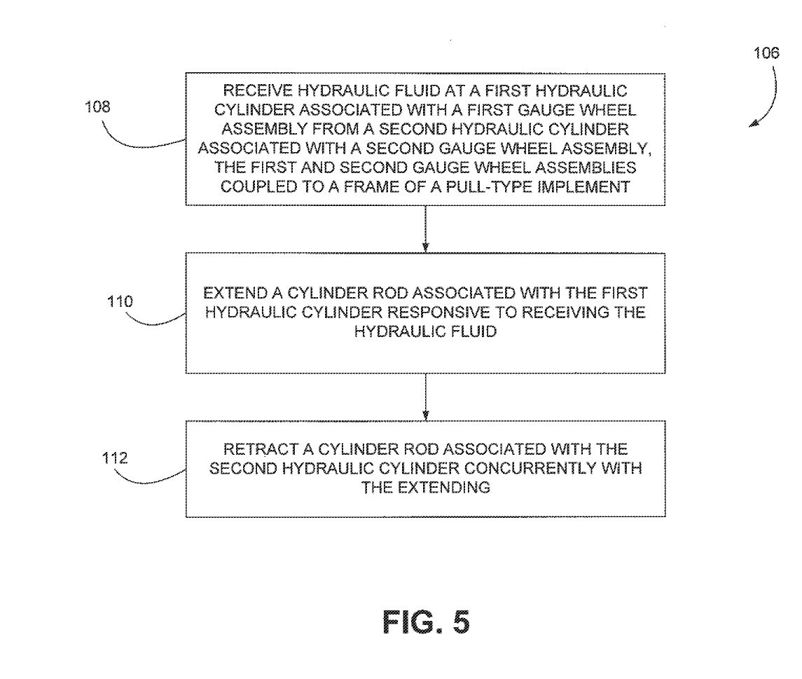

Having described certain embodiments of a hydraulic walking beam, it should be appreciated that one method embodiment, depicted in FIG. 5 and designated as method 106, comprises receiving hydraulic fluid at a first hydraulic cylinder associated with a first gauge wheel assembly from a second hydraulic cylinder associated with a second gauge wheel assembly, the first and second gauge wheel assemblies coupled to a frame of a pull-type implement (108); extending a cylinder rod associated with the first hydraulic cylinder responsive to receiving the hydraulic fluid (110); and retracting a cylinder rod associated with the second hydraulic cylinder concurrently with the extending (112).

It should be emphasized that the above-described embodiments of the present disclosure are merely possible examples of implementations, merely set forth for a clear understanding of the principles of the hydraulic walking beam and associated system and method embodiments. Many variations and modifications may be made to the above-described embodiment(s) without departing substantially from the spirit and principles of the disclosure. Although all such modifications and variations are intended to be included herein within the scope of this disclosure and protected by the following claims, the following claims are not necessarily limited to the particular embodiments set out in the description.

What is claimed is:

1. A system, comprising:
a frame of a pull-type implement; and
a first gauge wheel assembly and a second gauge wheel assembly, each of the first and second gauge wheel assemblies coupled to the frame, each of the first and second gauge wheel assemblies comprising:
a castor pivot assembly comprising a stud;
an axle having an upper end and a lower end, the upper end pivotably coupled to the stud;
a walking beam coupled to the lower end and to a wheel; and
a parallel linkage pivotably coupled between the first castor pivot assembly and the frame, the parallel linkage comprising:
an upper arm comprising first plural pivot points;
a lower arm comprising second plural pivot points; and
plural ears coupled to opposing sides of the lower arm, the plural ears having a cross member coupled to a hydraulic cylinder, wherein the hydraulic cylinder of the first gauge wheel assembly is hydraulically coupled to the hydraulic cylinder of the second gauge wheel assembly.

2. The system of claim 1, wherein the hydraulic cylinder of the first gauge wheel assembly operates concurrently with the hydraulic cylinder of the second gauge wheel assembly.

3. The system of claim 2, wherein the hydraulic cylinder of the first gauge wheel assembly comprises a first cylinder rod and the hydraulic cylinder of the second gauge wheel assembly comprises a second cylinder rod, wherein the first cylinder rod moves in a direction opposite to a direction the second cylinder rod moves.

4. The system of claim 1, wherein the hydraulic cylinder of the first gauge wheel assembly comprises a first cylinder rod extendable from and retractable into a first main body and the hydraulic cylinder of the second wheel assembly comprises a second cylinder rod extendable from and retractable into a second main body, wherein a length of the first and second cylinder rod is equal, wherein an exposed length of the first cylinder rod while the wheel of the first gauge wheel assembly is in contact with a surface at a first elevation is different than an exposed length of the second cylinder rod while the wheel of the second gauge wheel assembly is in contact with the surface at a second elevation.

5. The system of claim 1, further comprising an additional wheel for each of the first and second gauge wheel assemblies.

6. The system of claim 1, further comprising a tee assembly, the tee assembly comprising:
a tee;
a first hose assembly connected between a first connection of the tee and the hydraulic cylinder of the first gauge wheel assembly;
a second hose assembly connected between a second connection of the tee and the hydraulic cylinder of the second gauge wheel assembly; and
a third hose assembly connected between a directional valve of a towing vehicle and a third connection of the tee.

7. The system of claim 6, wherein one or more of the first, second, or third hose assemblies comprise one or more respective hoses.

8. The system of claim 7, wherein when the first, second, or third hose assembly comprises more than a single hose, the first, second, or third hose assembly further comprises one or more couplers.

9. The system of claim 1, wherein the frame comprises one or more main lift hydraulic cylinders coupled to a depth control valve, wherein the hydraulic cylinders of the first and second first and second gauge wheel assemblies are further hydraulically coupled to the one or more main lift hydraulic cylinders.

10. The system of claim 1, wherein the frame comprises plural wheels coupled thereto.

11. A hydraulic walking beam for a pull-type implement, the hydraulic walking beam comprising:
a first parallel linkage for a first gauge wheel assembly and a second parallel linkage for a second gauge wheel assembly, the first and second parallel linkages each coupled to a frame of the pull-type implement, each of the first and second parallel linkages comprising:
an upper arm comprising first plural pivot points;
a lower arm comprising second plural pivot points; and
plural ears coupled to opposing sides of the lower arm, the plural ears having a cross member coupled to a hydraulic cylinder, wherein the hydraulic cylinder of the first gauge wheel assembly is hydraulically coupled to the hydraulic cylinder of the second gauge wheel assembly.

12. The hydraulic walking beam of claim 11, wherein each of first and second gauge wheel assemblies comprises:
a castor pivot assembly comprising a stud;
an axle having an upper end and a lower end, the upper end pivotably coupled to the stud; and
a walking beam coupled to the lower end and to a wheel.

13. The hydraulic walking beam of claim 12, further comprising an additional wheel coupled to the walking beam.

14. The hydraulic walking beam of claim 11, further comprising a tee assembly, the tee assembly comprising:
a tee;
a first hose assembly connected between a first connection of the tee and the hydraulic cylinder of the first gauge wheel assembly;
a second hose assembly connected between a second connection of the tee and the hydraulic cylinder of the second gauge wheel assembly; and
a third hose assembly connected between a directional valve of a towing vehicle and a third connection of the tee.

15. The hydraulic walking beam of claim 14, wherein one or more of the first, second, or third hose assemblies comprise one or more respective hoses.

16. The hydraulic walking beam of claim 15, wherein when the first, second, or third hose assembly comprises more than a single hose, the first, second, or third hose assembly further comprises one or more couplers.

17. The hydraulic walking beam of claim 11, wherein the hydraulic cylinders of the first and second first and second gauge wheel assemblies are further hydraulically coupled to one or more main lift hydraulic cylinders coupled to the frame.

18. A hydraulic walking beam method of a pull-type implement, the method comprising:
receiving hydraulic fluid at a first hydraulic cylinder associated with a first gauge wheel assembly from a second hydraulic cylinder associated with a second gauge wheel assembly, the first and second gauge wheel assemblies coupled to a frame of a pull-type implement;
extending a cylinder rod associated with the first hydraulic cylinder responsive to receiving the hydraulic fluid; and
retracting a cylinder rod associated with the second hydraulic cylinder concurrently with the extending.

19. The method of claim 18, wherein receiving is responsive to an elevation change incurred by a wheel of the second gauge wheel assembly.

20. The method of claim 18, further comprising receiving hydraulic fluid at the first and second gauge wheel assemblies from either a tee, the tee hydraulically coupled to a directional valve of a towing vehicle, or one or more main lift hydraulic cylinders coupled to the frame.
